(19) United States
(12) Patent Application Publication
(10) Pub. No.: US 2026/0219959 A1
(43) Pub. Date: Jul. 30, 2026

(54) UNCORE FREQUENCY CONTROL DEVICE, UNCORE FREQUENCY CONTROL METHOD, AND UNCORE FREQUENCY CONTROL PROGRAM

(71) Applicant: NTT, Inc., Tokyo (JP)

(72) Inventors: Katsumi FUJITA, Tokyo (JP); Masashi KANEKO, Tokyo (JP); Harumoto FUKUDA, Tokyo (JP); Hirofumi NOGUCHI, Tokyo (JP); Yoshito ITO, Tokyo (JP)

(73) Assignee: NTT, Inc., Tokyo (JP)

(21) Appl. No.: 19/143,379

(22) PCT Filed: Dec. 28, 2022
(86) PCT No.: PCT/JP2022/048471

§ 371 Date: Jun. 26, 2025

(51) Int. Cl. G06F 9/50; G06F 11/34

(52) U.S. Cl. CPC G06F 9/5083; G06F 11/3409

(57) ABSTRACT

An uncore frequency control device includes: a requirement acquisition unit that acquires a user requirement; a data collection unit that collects prior data including an App performance value, power consumption, and hardware (HW) operation status data of the compute; a frequency-per-load-amount determination unit that determines a setting value of the uncore frequency for each of the load amount; a control rule creation unit that creates a control rule by replacing each of the load amount with performance data serving as a control determination reference value for determining the uncore frequency; a monitoring unit that acquires the load amount of a current time point from the compute; an uncore frequency determination unit that determines an uncore frequency by applying the load amount of the current time point to the control rule; and a frequency control unit that causes the determined uncore frequency to be set in the compute.

### TECHNICAL FIELD

The present invention relates to an uncore frequency control device, an uncore frequency control method, and an uncore frequency control program.

### BACKGROUND ART

In the operation and management of servers, the problem of power consumption has been regarded as important, and technologies for power saving have been studied. For example, improvement of resource utilization rate by a dynamic voltage and frequency scaling (DVFS) or a virtualization technology can be cited. The DVFS is a technology of controlling a voltage and a frequency of a CPU core. On the other hand, in recent years, a CPU has appeared that is capable of setting different operation frequencies in a core and a portion (uncore) other than the core in a CPU package. The core portion includes a CPU core and L1 and L2 caches. The uncore portion includes an L3 cache, a memory controller, a system bus, and the like.

Intel (registered trademark, the same shall apply hereinbelow) has introduced a function called an uncore frequency scaling (UFS) to the CPU in which the operation frequency can be set separately for the core and the uncore described above. The function of UFS allows the processor to dynamically change the uncore frequency according to the load, and a power saving effect similar to that of the DVFS of the CPU core to be obtained (see Non-Patent Literature 1).

On the other hand, Linux (registered trademark) has adopted a technology capable of setting the minimum/maximum frequency of scaling via the sysfs.

In addition, in research on operation frequency control of the uncore, a control technique for high-performance compute (HPC) has been proposed (see Non-Patent Literature 2).

In Non-Patent Literature 2, an application (App) performance analysis regarding a change in the uncore frequency is performed based on measurement using a benchmark for a plurality of processing characteristics. This research concludes that it is difficult for the UFS to perform optimum frequency control on all Apps, and that it is necessary to perform control according to characteristics and user requirements of Apps, and thus, proposes a unique control technique of the uncore frequency.

### CITATION LIST

### Non-Patent Literature

Non-Patent Literature 1: Srinivas Pandruvada, “Intel Uncore Frequency Scaling,” Intel Corporation, 2022, [online], [Retrieved on Dec. 20, 2022], the Internet <URL: https://www.kernel.org/doc/html/latest/admin-guide/pm/intel_uncore_frequency_scaling.html> Non-Patent Literature 2: Andre, Etienne, et al., “DUF: Dynamic Uncore Frequency scaling to reduce power consumption”, Concurrency and Computation: Practice and Experience 34.3 (2022): e6580.

### SUMMARY OF INVENTION

### Technical Problem

However, an application targeted in existing research such as Non-Patent Literature 2 is a numerical calculation program used in natural science research, but a control technique regarding an uncore operation frequency in a service system such as a web server has not been proposed.

There is a difference between a numerical calculation program and a web application in that the former is batch processing and the latter is real-time processing, and this difference also appears in evaluation viewpoints on both. In the batch processing, the performance is evaluated by the processing completion time, and the power is evaluated on the basis of a power consumption required until the processing is completed. On the other hand, in the real-time processing, a performance is evaluated on the basis of a response time and a throughput, and power is evaluated on the basis of a power consumption.

The present invention has been made in view of such points, and an object of the present invention is to provide an optimum uncore frequency control method for real-time processing of a web application or the like.

### Solution to Problem

An uncore frequency control device according to the present invention is an uncore frequency control device that controls an uncore frequency of a physical server group being pieces of compute in which an application (App) that executes real-time processing is implemented, the uncore frequency control device including: a requirement acquisition unit that acquires a user requirement regarding performance and power consumption; a data collection unit that changes a load amount applied to the compute and an uncore frequency respectively set in the compute and collects prior data including an App performance value, power consumption, and hardware (HW) operation status data of the compute for a predetermined period; a frequency-per-load-amount determination unit that refers to the prior data, extracts an uncore frequency that satisfies the user requirement for each of the load amount, and determines a setting value of the uncore frequency for each of the load amount; a control rule creation unit that creates a control rule indicating an uncore frequency to be set according to a value of the load amount by replacing each of the load amount with performance data serving as a control determination reference value for determining the uncore frequency using the setting value of the uncore frequency for each of the load amount; a monitoring unit that acquires a load amount of a current time point indicated by the HW operation status data from the compute on which the App is executing the real-time processing; an uncore frequency determination unit that determines an uncore frequency to be set in the compute by applying the control rule using the load amount of the current time point acquired from the compute; and a frequency control unit that transmits the uncore frequency that has been determined to the compute and causes the compute to set the uncore frequency.

### Advantageous Effects of Invention

The present invention is able to provide an optimum uncore frequency control technique for real-time processing such as a web application.

### BRIEF DESCRIPTION OF DRAWINGS

FIG. 1 is a diagram illustrating an overall configuration of an uncore frequency control system including an uncore frequency control device according to the present embodiment.

FIG. 2 is a diagram illustrating an example of a result of collecting data from a compute by the uncore frequency control device according to the present embodiment.

FIG. 3 is a diagram illustrating extraction processing of an uncore frequency candidate for each load amount by the uncore frequency control device according to the present embodiment.

FIG. 4 is a diagram illustrating an example of a control rule created by the uncore frequency control device according to the present embodiment.

FIG. 5 is a diagram illustrating an example of the control rule created by the uncore frequency control device according to the present embodiment.

FIG. 6 is a flowchart illustrating a flow of entire processing performed by the uncore frequency control device according to the present embodiment.

FIG. 7 is a flowchart illustrating a flow of data collection processing performed by the uncore frequency control device according to the present embodiment.

FIG. 8 is a flowchart illustrating a flow of frequency-per-load-amount determination processing performed by the uncore frequency control device according to the present embodiment.

FIG. 9 is a flowchart illustrating a flow of control rule creation processing performed by the uncore frequency control device according to the present embodiment.

FIG. 10 is a flowchart illustrating a flow of uncore frequency control processing <1> performed by the uncore frequency control device according to the present embodiment.

FIG. 11 is a flowchart illustrating a flow of uncore frequency control processing <2> performed by the uncore frequency control device according to the present embodiment.

FIG. 12 is a hardware configuration diagram illustrating an example of a computer that implements functions of the uncore frequency control device according to the present embodiment.

### DESCRIPTION OF EMBODIMENTS

Next, a mode for carrying out the present invention (hereinafter referred to as the “present embodiment”) is described.

An uncore frequency control device according to the present embodiment collects App performance values, power consumption, and hardware (HW) operation status data for a predetermined period in a state where a certain load is applied, and determines an optimum frequency for each load amount. Then, the uncore frequency control device replaces each load amount with performance data serving as a control determination reference value, and creates a control rule of the uncore frequency. The uncore frequency control device acquires HW operation status data from each piece of compute (physical server) to be controlled, determines an optimum uncore frequency on the basis of a control rule created in advance, and controls the uncore frequency of each piece of computes (physical server).

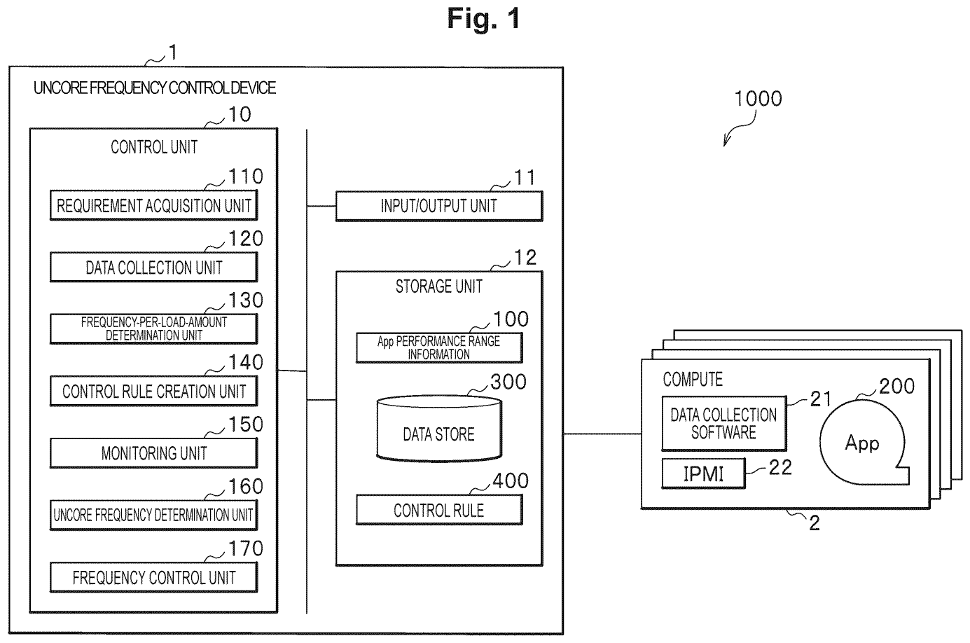

FIG. 1 is a diagram illustrating an overall configuration of an uncore frequency control system 1000 including an uncore frequency control device 1 according to the present embodiment.

As illustrated in FIG. 1, the uncore frequency control device 1 is communicably connected to each piece of compute (physical server) 2 whose uncore frequency is to be controlled.

In each piece of compute 2, an application (App) 200 is implemented on hardware (HW). The App 200 may be implemented in a virtual machine (VM) or a container. Each piece of compute 2 includes data collection software 21 and intelligent platform management interface (IPMI) 22.

The data collection software 21 is software that collects performance data of the compute 2, and acquires the App performance value and the HW operation status data.

The App performance value is, for example, a response time or a throughput. The HW operation status data is an index serving as a reference of a load amount of the compute 2, and adopts performance data that can be acquired from each compute 2 such as a CPU usage rate, a cache miss, and the number of received packets, and a performance value obtained from a log of an App operating on the compute 2. The HW operation status data also serves as a reference for control determination of the uncore frequency described below (details is described below).

As the data collection software 21, existing data collection software such as Perf, dstat or self-made software can be used.

The IPMI 22 is a standard interface for monitoring and managing the state of hardware, and includes power consumption measurement means. The IPMI 22 measures the power consumption of the compute 2 when a load is applied by implementing the App 200. The power consumption measurement means is not limited to the IPMI 22, and when the compute 2 includes a power meter, the power consumption may be measured by the power meter.

The compute 2 transmits to the uncore frequency control device 1 the App performance value, the HW operation status data, and the information on the power consumption when the load is applied to the implemented App 200. Then, the compute 2 acquires the setting information of the uncore frequency from the uncore frequency control device 1, and sets the optimum uncore frequency according to the load.

### <<Uncore Frequency Control Device>>

Next, a description is provided on the uncore frequency control device 1 and the like according to the present embodiment.

The uncore frequency control device 1 acquires requirements (hereinafter, referred to as a “user requirement”) regarding performance and a reduction effect of power consumption from a user in advance. Then, the uncore frequency control device 1 collects App performance values, power consumption, and HW operation status data for a predetermined period in a state where a certain load is applied, and determines an uncore frequency satisfying the user requirement for each load amount. By using the determination result, the uncore frequency control device 1 replaces each load amount with performance data serving as a control determination reference value, and creates a control rule of the uncore frequency in advance. The uncore frequency control device 1 acquires HW operation status data from each piece of compute (physical server) 2 to be controlled, determines an optimum uncore frequency on the basis of a control rule created in advance, and controls the uncore frequency of each piece of compute (physical server) 2.

As illustrated in FIG. 1, the uncore frequency control device 1 includes a control unit 10, an input/output unit 11, and a storage unit 12.

The input/output unit 11 inputs and outputs information from and to each piece of compute 2 or the like. The input/output unit 11 includes a communication interface for transmitting and receiving information via a communication line, and an input/output interface that inputs and outputs information to and from an input device such as a keyboard (not illustrated) and an output device such as a monitor (not illustrated).

The storage unit 12 includes a hard disk, a flash memory, a random access memory (RAM), or the like.

The storage unit 12 stores App performance range information 100, a data store 300, and a control rule 400.

The App performance range information 100 stores information indicating which App or a function group constituting the App is mounted on which compute 2, and stores information indicating whether or not performance requirements of the entire App (or a function group constituting the App) are set (information indicating whether or not setting of the performance requirements of the entire App is necessary).

In an App (or a function group constituting the App), there are a case where a performance requirement is set for the entire App (a case where it is necessary to consider the entire performance) and a case where it is not necessary to consider the performance requirement for a part (for example, a function of performing processing that applies a load to a memory) of the App (or the function group constituting the App), and the performance requirement is not set for the part (a case where it is not necessary to consider the performance for the part). For example, in a case where high-speed processing is not required even in processing in which a load is concentrated on a memory, it is not necessary to consider a performance requirement of a DB (DB server).

In this case, there is a case where a DB (DB server) is constructed in a physical server different from the physical server that processes the Web or the application. Therefore, information as to whether all the function groups constituting the App are operated on the same physical server, or whether a function applying a load to a part of the memory among the function groups constituting the App is operated in another physical server (DB server) is also stored in the App performance range information 100.

The data store 300 stores an App performance value, power consumption, and HW operation status data collected from each piece of compute 2 by a data collection unit 120 to be described below. In addition, in the data store 300, a setting value of an optimum uncore frequency for each load amount determined by the frequency-per-load-amount determination unit 130 described below is stored for each piece of compute 2.

In the control rule 400, information on the optimum uncore frequency according to the HW operation status data (for example, CPU usage rate) created by a control rule creation unit 140 described below is stored as a control rule for each piece of compute 2.

The control unit 10 supervises overall processing executed by the uncore frequency control device 1, and includes a requirement acquisition unit 110, a data collection unit 120, a frequency-per-load-amount determination unit 130, a control rule creation unit 140, a monitoring unit 150, an uncore frequency determination unit 160, and a frequency control unit 170.

The requirement acquisition unit 110 acquires a requirement (user requirement) regarding a reduction effect of performance and power consumption from the user in advance. Specifically, the user requirements are acquired from a system management device (not illustrated) or the like via the input/output unit 11.

This user requirement includes the following three elements:
“Performance priority or energy saving priority”
“Ratio allowing performance degradation” (hereinafter, referred to as “performance degradation requirement”).
“Power consumption reduction effect” (hereinafter, referred to as “power reduction requirement”).

In the “performance priority or energy saving priority,” for example, energy saving priority is set as a requirement.

In the “ratio allowing performance degradation,” for example, it is set that 5% performance degradation from the maximum performance value is allowed.

In the “power consumption reduction effect,” for example, 10% reduction from the maximum power consumption is set.

Next, the data collection unit 120 collects prior data including the App performance value, the power consumption, and the HW operation status data from each piece of compute 2 for a predetermined period in a state where a certain load is applied, and stores the prior data in the data store 300.

Specifically, the data collection unit 120 executes the following procedures 1 to 3.

(Procedure 1) The App performance value, the power consumption, and the HW operation status data are collected for a predetermined period in a state where a certain load is applied. At this time, the uncore frequency is fixed.

(Procedure 2) The load amount in (Procedure 1) is not changed, the uncore frequency is changed in a predetermined unit (for example, in units of 100 MHz), and similar data to that in (Procedure 1) is collected for a predetermined period in the entire settable range of the uncore frequency.

(Procedure 3) Data is collected with a load amount different from that of (Procedure 1), similarly to (Procedure 1) and (Procedure 2).

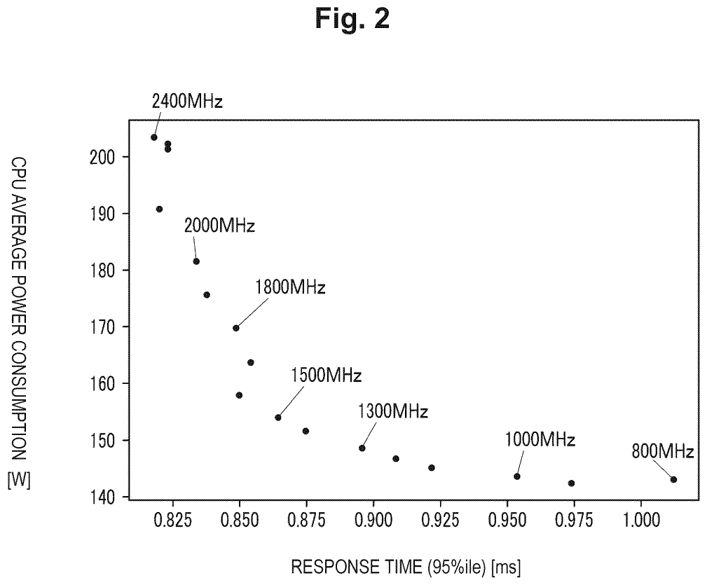

FIG. 2 is a diagram illustrating an example of a result of the data collection unit 120 collecting data from the compute 2.

Here, the CPU usage rate is used as the HW operation status data, the response time is used as the App performance value, and the power consumed by the CPU package (total of CPU “0” and CPU “1”) is used as the power consumption. FIG. 2 is a graph illustrating the relationship between the response time and the CPU average power consumption when the uncore frequency is changed in units of 100 MHz in the range of 800 MHz to 2400 MHz in a state where the CPU usage rate (average)=10% as the load.

As illustrated in FIG. 2, the higher the uncore frequency, the shorter the response time and the higher the CPU average power consumption.

Returning to FIG. 1, the frequency-per-load-amount determination unit 130 extracts the uncore frequency satisfying the user requirement acquired by the requirement acquisition unit 110 for each load amount with reference to the prior data, and determines the setting value of the optimum uncore frequency from among the extracted uncore frequencies.

Specifically, the frequency-per-load-amount determination unit 130 extracts an uncore frequency that satisfies both of the requirements “ratio allowing performance degradation” and “power consumption reduction effect” among the user requirements. Here, for example, the frequency-per-load-amount determination unit 130 extracts an uncore frequency that satisfies both “5% performance degradation from the maximum performance value is allowed” and “10% reduction from the maximum power consumption”.

In the case of the load (CPU usage rate (average)=10%) in FIG. 2 described above, the uncore frequency satisfying the following expression is extracted.

Performance (X-axis) threshold=minimum response time×1.05=0.819×1.05=0.86 [ms]

Power (Y-axis) threshold=power consumption×0.9=203×0.9=183 [W]

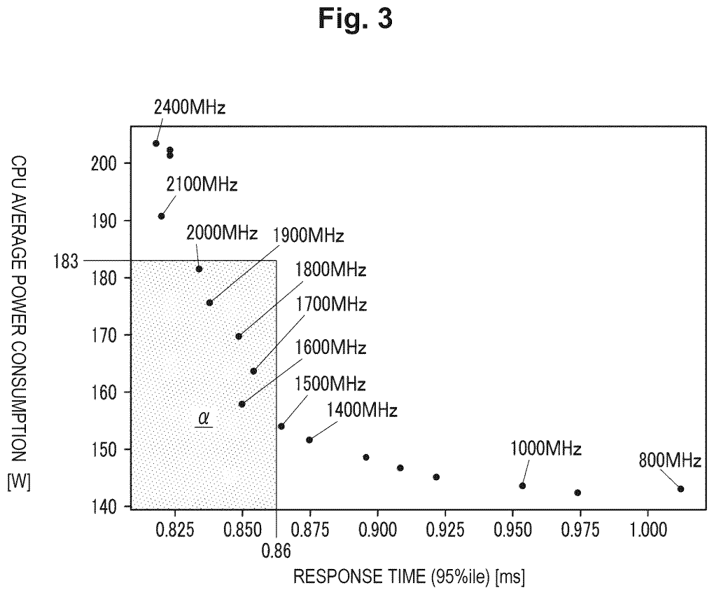

The uncore frequencies that satisfy both the performance degradation requirement (performance threshold) and the power reduction requirement (power threshold) are 1600, 1700, 1800, 1900, and 2000 [MHz] as indicated by a region a in FIG. 3. The frequency-per-load-amount determination unit 130 extracts the five uncore frequencies as candidates.

That is, the frequency-per-load-amount determination unit 130 extracts the following data.

### Load [1]

$$CPU usage rate ( average ) = 10 \%$$

Candidate uncore frequency [MHz]: 1600, 1700, 1800, 1900, and 2000

The frequency-per-load-amount determination unit 130 similarly extracts the uncore frequency as a candidate for other loads, for example, as follows.

### -Load [2]

$$CPU usage rate ( average ) = 50 \%$$

Candidate uncore frequency [MHz]: 1800, 1900, and 2000
Load [3]

$$CPU usage rate ( average ) = 80 \%$$

Candidate uncore frequency [MHz]: 2000

Subsequently, the frequency-per-load-amount determination unit 130 determines an optimum uncore frequency on the basis of the extracted information (candidate uncore frequency) on the basis of the following predetermined frequency determination logic.

(Logic 1) In a case where a plurality of frequencies are candidates, the following logic is adopted.

(Logic 1-1) In a case where “performance priority” is set in the user requirement, the uncore frequency of the maximum value among the candidates is determined as the setting value of the optimum frequency.

(Logic 1-2) In a case where “energy saving priority” is set in the user requirement, the uncore frequency of the minimum value among the candidates is determined as the setting value of the optimum frequency.

(Logic 1-3) In a case where the optimum frequency width is set to an optimum value in advance, the uncore frequency in the optimum range is set. For example, when the optimum range is 1 GHz to 2 GHZ, the maximum value of the uncore frequency is set to 2 GHz, and the minimum value is set to 1 GHz.

(Logic 2) In a case where a single frequency is a candidate, the frequency is determined as the setting value of the optimum uncore frequency.

(Logic 3) In a case where there is no candidate, a predetermined logic is preset and calculated. As the predetermined logic, the following method is set in advance. For example, an uncore frequency extracted at a load amount close to a load amount for which there is no candidate is adopted. The average value of the setting values of the uncore frequency extracted at the load amount having the upper and lower values of the load amount having no candidate is adopted. The load amount having no candidate is changed to a load amount shifted by a predetermined amount (several MHz), data is collected again at the shifted load amount, and an uncore frequency as a candidate is extracted. Performance and/or power threshold requirements are relaxed. Any one of the above candidates is set in advance in the frequency-per-load-amount determination unit 130.

As described above, the frequency-per-load-amount determination unit 130 determines the setting value of the optimum uncore frequency that satisfies the user requirement for each load amount.

Returning to FIG. 1, the control rule creation unit 140 generates the control rule by using the setting value of the optimum uncore frequency for each load amount determined by the frequency-per-load-amount determination unit 130.

This control rule is a rule for determining the optimum uncore frequency according to the value of the HW operation status data obtained by monitoring the operating compute 2 by the monitoring unit 150 described below.

The control rule creation unit 140 creates a control rule indicating an optimum uncore frequency to be set according to the value of the load amount by replacing each load amount with performance data serving as a control determination reference value.

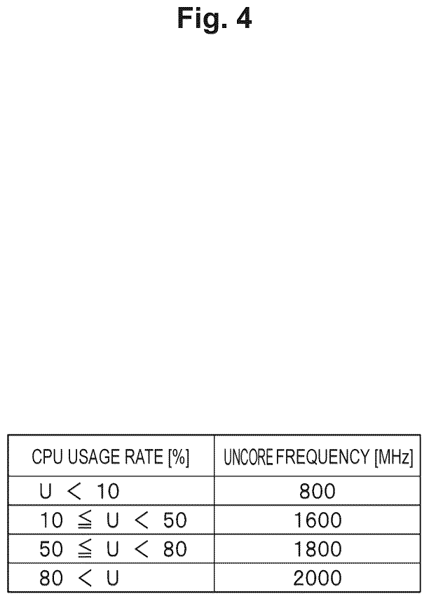

FIG. 4 illustrates a control rule 400 in a case where “energy saving priority” is set in the user requirement in the above-described loads [1] to [3].

In a case where “energy saving priority” is set in the user requirement, because a plurality of frequencies are candidates in the load [1], the frequency-per-load-amount determination unit 130 determines the setting value of the optimum uncore frequency to be the minimum value 1600 [MHz] among the candidates according to (Logic 1-2). As similar to this, with respect to the load [2], the frequency-per-load-amount determination unit 130 determines the setting value to be the minimum value of 1800 [MHz] among the candidates. With respect to the load [3], because a single frequency is a candidate, the frequency-per-load-amount determination unit 130 sets the setting value of the optimum uncore frequency to 2000 [MHz] by (Logic 2).

On the basis of these pieces of information, the control rule creation unit 140 replaces each load amount with performance data serving as a control determination reference value, and creates the control rule 400.

FIG. 4 illustrates an example in which the control determination reference value is set using the CPU usage rate which is the measurement data (HW operation status data). In this case, the CPU usage rate (10%, 50%, 80%) is used as the control determination reference value.

When the measured CPU usage rate (U) is 10% or less, the control rule creation unit 140 determines the frequency to be 800 [MHz], which is the lowest frequency among the settable uncore frequencies (U<10). Hereinafter, when the CPU usage rate is 10% or more and less than 50%, the control rule creation unit 140 determines the frequency to be 1600 [MHz]. When the CPU usage rate is 50% or more and less than 80%, the control rule creation unit 140 determines the frequency to be 1800 [MHz]. When the CPU usage rate is 80% or more, the control rule creation unit 140 determines the frequency to be 2000 [MHz].

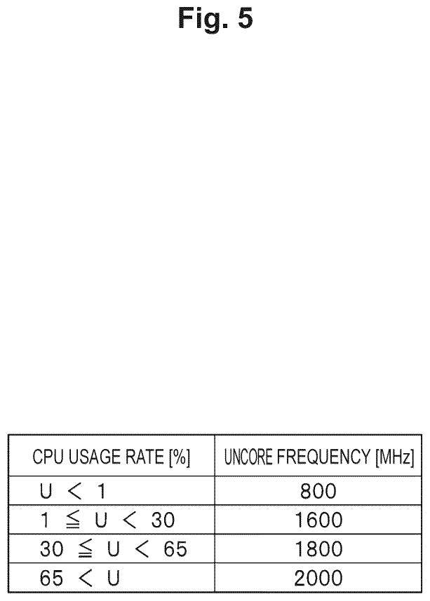

FIG. 5 illustrates an example in which the control determination reference value is set at an intermediate value of the CPU usage rate (10%, 50%, 80%) which is the measurement data. In this case, the CPU usage rate (30%, 65%) is used as the control determination reference value. Here, when the measured CPU usage rate is 1% or less, the control rule creation unit 140 determines the frequency to be 800 [MHz], which is the lowest frequency among the settable uncore frequencies.

When the measured CPU usage rate (U) is 1% or more and less than 30%, the control rule creation unit 140 determines the CPU usage rate as 1600 [MHz]. When the CPU usage rate is 30% or more and less than 65%, the control rule creation unit 140 determines the frequency to be 1800 [MHz]. When the CPU usage rate is 65% or more, the control rule creation unit 140 determines the frequency to be 2000 [MHz].

As described above, the control rule creation unit 140 replaces each load amount with performance data serving as a control determination reference value, and creates the control rule 400. Then, the control rule creation unit 140 stores the created control rule 400 for each piece of compute 2 in the storage unit 12.

Returning to FIG. 1, the monitoring unit 150 acquires the HW operation status data (for example, CPU usage rate) indicating the current load amount from each piece of compute 2 when the web service or the like is actually operated. At this time, the monitoring unit 150 acquires information such as a cache miss and a memory bandwidth in order to determine whether the processing is processing in which a load is concentrated on the memory (details is described below).

Then, the monitoring unit 150 outputs the collected HW operation status data and the like to the uncore frequency determination unit 160.

Even in a case where the performance value of the App to be used cannot be obtained from the log information of the compute 2, the monitoring unit 150 can acquire the App performance value and the HW operation status data by the data collection software 21 provided in the compute 2.

The uncore frequency determination unit 160 calculates the optimum uncore frequency at the current time point by applying the control rule 400 stored in the storage unit 12 by using the HW operation status data (current load amount) acquired by the monitoring unit 150 and the like. Then, the uncore frequency determination unit 160 compares the calculated optimum uncore frequency at the current time point with the currently set uncore frequency in the compute 2, and determines the calculated optimum uncore frequency at the current time point as the optimum uncore frequency of the compute 2 in a case where the calculated optimum uncore frequency is not the same.

The uncore frequency determination unit 160 stores information of the currently set uncore frequency in the compute 2 in the storage unit 12 when the uncore frequency is set in the compute 2. Then, the uncore frequency determination unit 160 may use the stored information to compare with the calculated optimum uncore frequency at the current time point, or may acquire information of the current uncore frequency from each piece of compute 2 to compare.

In a case where the information of the uncore frequency set in each piece of compute 2 is stored in the storage unit 12, the uncore frequency determination unit 160 executes the following processing.

When the HW operation status data of the compute 2 is acquired for the first time during operation, the uncore frequency determination unit 160 determines the uncore frequency calculated this time as the uncore frequency of the compute 2 and stores the uncore frequency in the storage unit 12.

Furthermore, the uncore frequency determination unit 160 compares the uncore frequency determined this time with the uncore frequency stored in the storage unit 12, and performs control to change the uncore frequency of the compute 2 to the this-time determined uncore frequency if the uncore frequencies are not the same. Then, the uncore frequency determination unit 160 updates the uncore frequency stored in the storage unit with the changed uncore frequency.

Furthermore, when determining the optimum uncore frequency, the uncore frequency determination unit 160 executes processing with reference to the App performance range information 100 stored in the storage unit 12.

Specifically, the uncore frequency determination unit 160 refers to the App performance range information 100, and executes the determination processing of the optimum uncore frequency in a case where the performance requirement is set for the entire App and a case where it is not necessary to consider the performance requirement for a part of the App.

In a case where the performance requirement is set for the entire App, the uncore frequency determination unit 160 compares the current optimum uncore frequency calculation processing using the current HW operation status data with the set uncore frequency, and performs processing of changing to the calculated uncore frequency if they are not the same.

When it is not necessary to consider the performance requirement for a part of the App, for example, when it is not necessary to consider the performance requirement for a function that performs processing that applies a load to a part of the memory, the uncore frequency determination unit 160 applies the above-described processing of determining the uncore frequency of the current time point to a function group for which consideration of the performance requirement is necessary. More specifically, the uncore frequency determination unit 160 executes processing according to the following case classification.

When a function group for which the performance requirement is considered and a function group for which consideration of the performance requirement is not necessary are separately operated in different servers among the function groups constituting the App, the uncore frequency determination unit 160 executes the process of determining the current uncore frequency on the physical server on which the function group considering the performance requirement is operated.

On the other hand, the uncore frequency determination unit 160 sets an uncore frequency (for example, the minimum value of 800 [MHz]) lower than a predetermined threshold to the physical server on which the function group that is not considered about the performance requirement operates.

In addition, when all the function groups constituting the App operate on the same physical server, the uncore frequency determination unit 160 executes the above-described process of determining the current uncore frequency on the physical server on which the function group considering the performance requirement operates. However, the processing phase is constantly analyzed during the operation of the compute 2, and for example, in a phase in which the load is concentrated on the memory even when the load amount is large, an uncore frequency (for example, the minimum value of 800 [MHz]) lower than a predetermined threshold is set.

For the information on whether the load is concentrated on the CPU or the load is concentrated on the memory, for example, the monitoring unit 150 determines whether the current processing is processing in which the load is concentrated on the CPU or processing in which the load is concentrated on the memory by observing an index such as a cache miss or a memory bandwidth of the compute 2.

The frequency control unit 170 transmits the setting information of the uncore frequency determined by the uncore frequency determination unit 160 to each compute 2. As a result, each compute 2 receives the setting information and sets its own uncore frequency.

### <<Processing of Uncore Frequency Control Device>>

Next, processing executed by the uncore frequency control device 1 is described.

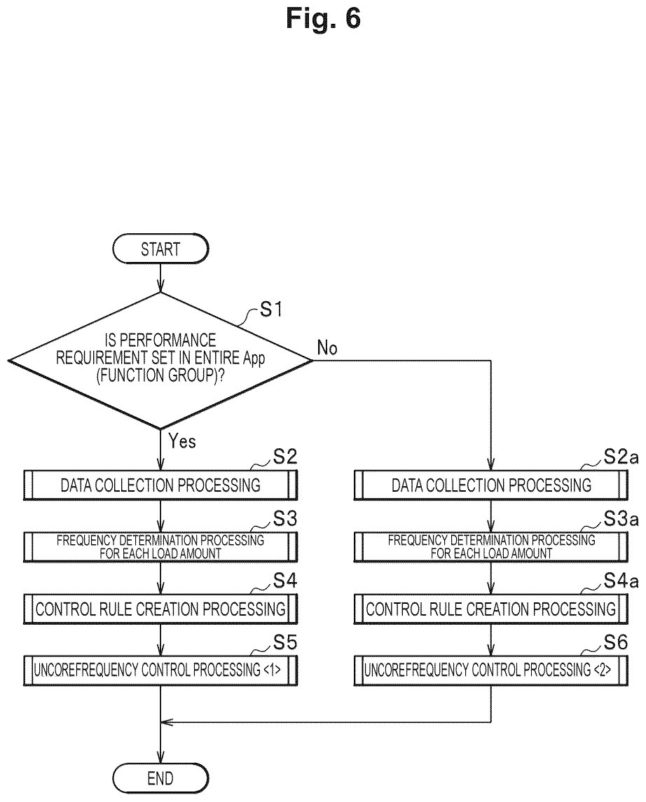

FIG. 6 is a flowchart illustrating a flow of entire processing performed by the uncore frequency control device 1 according to the present embodiment.

When determining the optimum uncore frequency, the uncore frequency control device 1 executes processing separately for a case where the performance requirement is set for the entire App and a case where it is not necessary to consider the performance requirement for a part of the App on the basis of the App performance range information 100 stored in the storage unit 12. Hereinafter, the overall flow executed for each piece of compute 2 is described.

First, the uncore frequency control device 1 selects one piece of compute 2, refers to the App performance range information 100 for the compute 2, and determines whether performance requirements are set for the entire App (or a function group constituting the App) (step S1).

Here, when it is determined that the performance requirements are set for the entire App (step S1: Yes), the following data collection processing (step S2), frequency determination processing for each load amount (step S3), control rule creation processing (step S4), and uncore frequency control processing <1> (step S5) are executed for the entire App.

On the other hand, when the performance requirement is not set for the entire App (step S1: No), that is, when it is not necessary to consider the performance requirement for a part of the App, the uncore frequency control device 1 executes the following data collection processing (step S2a), frequency determination processing for each load amount (step S3a), control rule generation processing (step S4a), and uncore frequency control processing <2> (step S6) on a function group for which consideration of the performance requirement is necessary among the entire App.

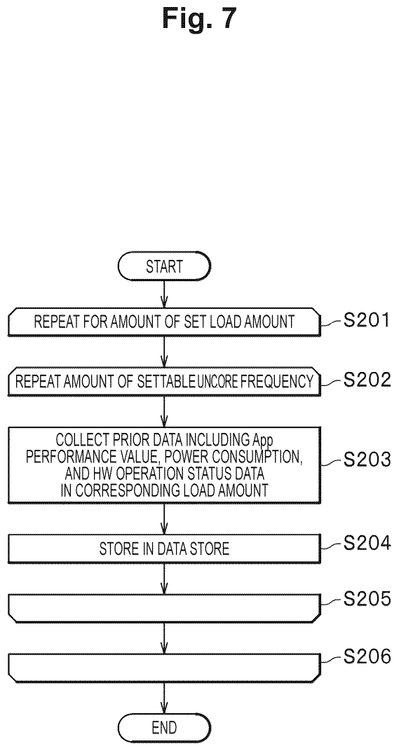

The data collection processing is processing of collecting the App performance value, the power consumption, and the HW operation status data from the compute 2 for a predetermined period in a state where a certain load is applied, by the data collection unit 120. Because the processing flow is the same between step S2 and step S2a although the range of the target App is different, only the processing of step S2 is described in detail with reference to FIG. 7 described below.

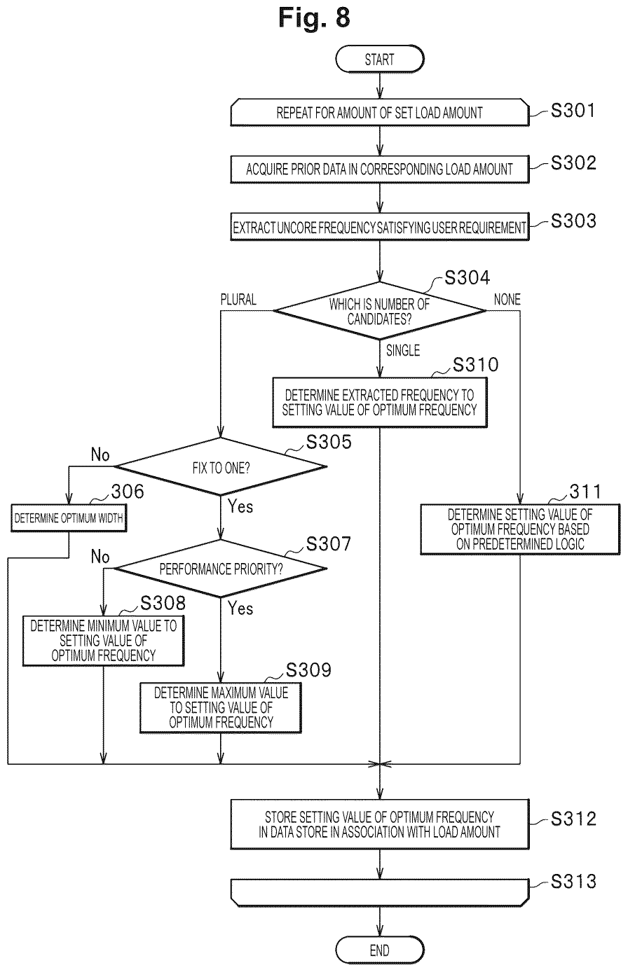

The frequency determination processing for each load amount is processing of extracting the uncore frequency satisfying the user requirement for each load amount and determining the setting value of the optimum uncore frequency from among the extracted uncore frequencies, by the frequency-per-load-amount determination unit 130. Because the processing flow is the same between step S3 and step S3a although the range of the target App is different, only the processing of step S3 is described in detail with reference to FIG. 8 described below.

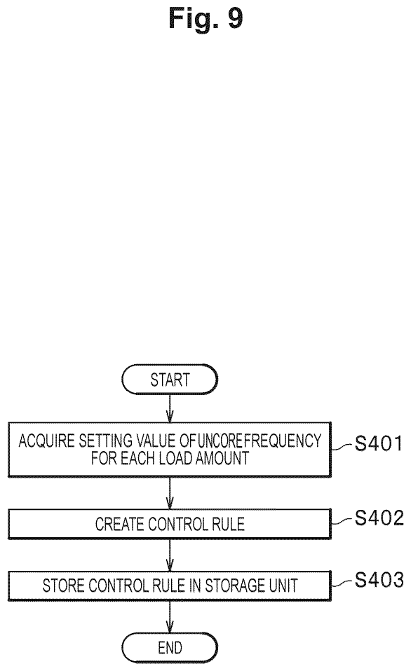

The control rule creation processing is processing of creating a control rule by replacing each load amount with the performance data serving as the control determination reference value by using the setting value of the optimum uncore frequency satisfying the user requirement for each load amount determined by the frequency-per-load-amount determination unit 130. Because the processing flow is the same between step S4 and step S4a although the range of the target App is different, only the processing of step S4 is described in detail with reference to FIG. 9 described below.

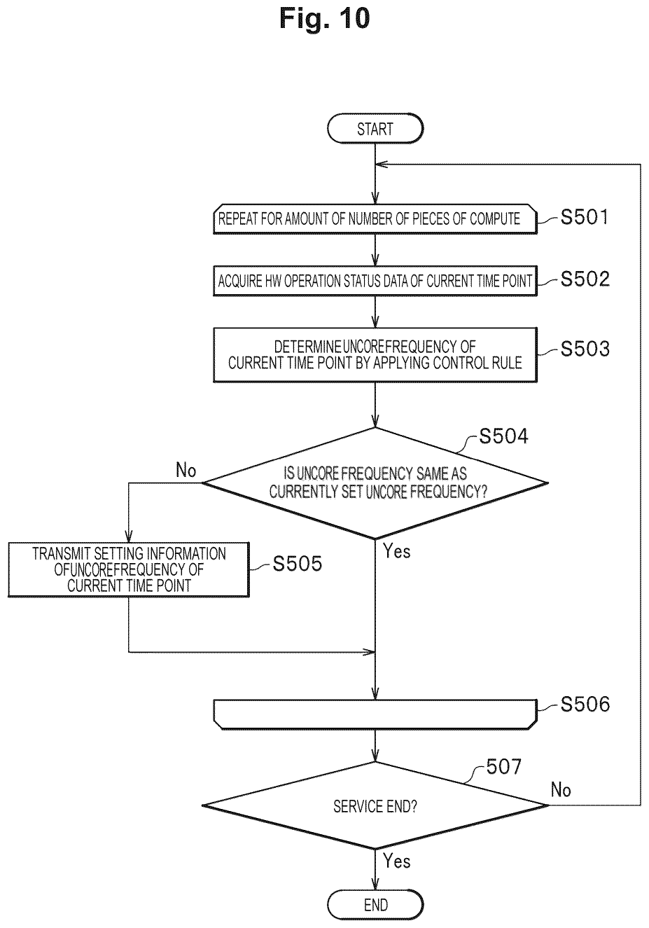

The uncore frequency control processing <1> is control processing of the uncore frequency for each piece of compute 2 in a case where it is determined that the performance requirements are set for the entire App, and is detailed with reference to FIG. 10 described below.

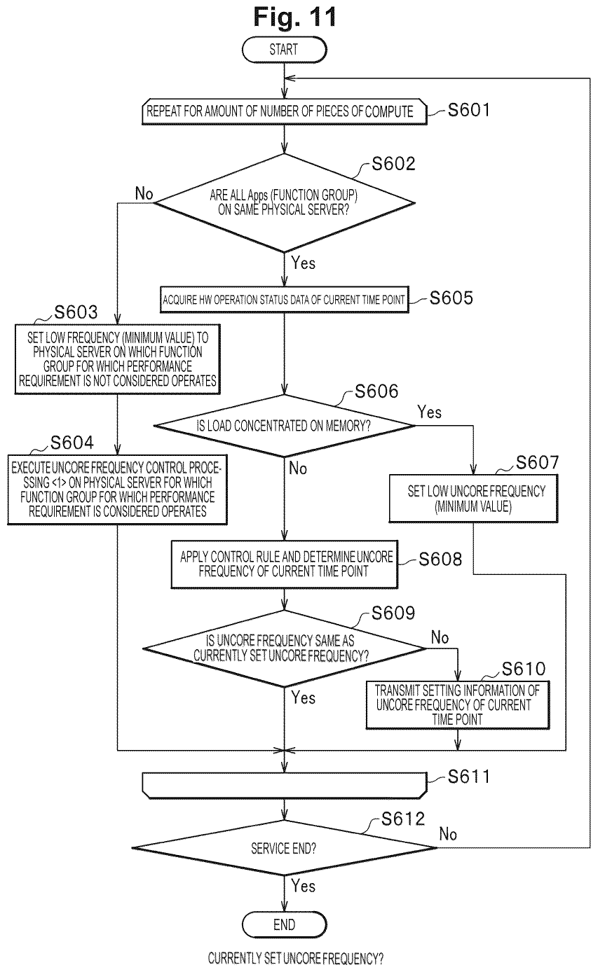

The uncore frequency control processing <2> is control processing of the uncore frequency for each piece of compute 2 in a case where it is not necessary to consider the performance requirement for a part of the App, and is detailed with reference to FIG. 11 described below.

### [Data Collection Processing]

FIG. 7 is a flowchart illustrating a flow of data collection processing performed by the uncore frequency control device 1 according to the present embodiment.

The data collection unit 120 of the uncore frequency control device 1 selects one load amount from a plurality of load amounts set in advance, executes the processing of steps S202 to S205, and repeats the plurality of set load amounts (steps S201 to S206).

Then, the data collection unit 120 selects one uncore frequency among the settable uncore frequencies. For example, the uncore frequency is set to be changed in units of 100 [MHz], and the minimum frequency is selected. Then, the data collection unit 120 executes the processing of steps S203 to S204, and repeats the processing of sequentially adding 100 [MHz] and selecting a settable uncore frequency (steps S202 to S205).

In step S203, the data collection unit 120 collects prior data including the App performance value, the power consumption, and the HW operation status data for a predetermined period in a state where the selected load is applied to the compute 2.

Then, in step S204, the data collection unit 120 stores information (prior data) of the acquired App performance value, power consumption, and HW operation status data in the data store 300 of the storage unit 12.

As a result, the uncore frequency control device 1 can obtain information of the App performance value, the power consumption, and the HW operation status data when the uncore frequency is changed for each load amount.

### [Frequency Determination Processing for Each Load Amount]

FIG. 8 is a flowchart illustrating a flow of frequency determination processing for each load amount performed by the uncore frequency control device 1 according to the present embodiment.

The frequency-per-load-amount determination unit 130 of the uncore frequency control device 1 extracts an uncore frequency that satisfies a user requirement (performance degradation requirement (performance threshold) and power reduction requirement (power threshold)) for each load amount, and executes frequency determination processing for each load amount of determining an optimum setting value of the uncore frequency from among the extracted uncore frequencies. Hereinafter, a specific description is given.

The frequency-per-load-amount determination unit 130 repeats a process of determining an optimum setting value of the uncore frequency as described below for each preset load amount (steps S301 to S313).

First, the frequency-per-load-amount determination unit 130 selects one of the preset load amounts and executes the processing in and after step S302.

In step S302, the frequency-per-load-amount determination unit 130 acquires, from the data store 300, the prior data for the load amount (for example, the CPU usage rate which is the HW operation status data), specifically, the App performance value (for example, the response time) and the information on power consumption (see FIG. 2).

Subsequently, the frequency-per-load-amount determination unit 130 extracts an uncore frequency that satisfies the user requirement acquired by the requirement acquisition unit 110 (step S303).

Specifically, the frequency-per-load-amount determination unit 130 extracts an uncore frequency that satisfies both of the requirements “ratio allowing performance degradation” (performance degradation requirement) and “power consumption reduction effect” (power reduction requirement) among the user requirements. For example, an uncore frequency is extracted as a candidate that satisfies “5% performance degradation from the maximum performance value is allowed” (performance threshold) as the performance degradation requirement and “10% reduction from the maximum power consumption” (power threshold) as the power reduction requirement.

Next, the frequency-per-load-amount determination unit 130 determines whether the number of candidates for the optimum uncore frequency extracted in step S303 is “plural”, “single”, or “none” (the number of candidates is 0) (step S304).

When the number of candidates is “plural” (step S303: plural), the frequency-per-load-amount determination unit 130 determines whether to fix the optimum frequency to one (step S305). When the optimum frequency is not fixed to one (step S305: No), that is, when the optimum frequency is determined as the optimum width, the process proceeds to the next step S306. Note that it is set in advance whether or not the optimum frequency is fixed to one or set to a width by the frequency-per-load-amount determination unit 130.

In step S306, the frequency-per-load-amount determination unit 130 determines the width between the minimum value and the maximum value among the candidates as the optimum width of the uncore frequency. For example, when 1800, 1900, and 2000 [MHz] are extracted as candidate uncore frequencies, the minimum value of 1800 [MHz] and the maximum value of 2000 [MHz] are determined as the optimum width of the uncore frequency. Then, the processing proceeds to step S312.

On the other hand, when it is determined in step S305 that the optimum frequency is fixed to one (step S305: Yes), the frequency-per-load-amount determination unit 130 determines whether “performance priority” is set in the user requirement “performance priority or energy saving priority” acquired by the requirement acquisition unit 110 (step S307).

Here, if “performance priority” is not set (step S307: No), that is, if “energy saving priority” is set, the frequency-per-load-amount determination unit 130 determines the minimum value among the candidate uncore frequencies as the setting value of the optimum frequency (step S308). Then, the processing proceeds to step S312.

On the other hand, if “performance priority” is set (step S307: Yes), the frequency-per-load-amount determination unit 130 determines the maximum value among the candidate uncore frequencies as the setting value of the optimum frequency (step S309). Then, the processing proceeds to step S312.

Returning to step S304, when the number of candidates for the optimum uncore frequency is “single” (step S304: single), the frequency-per-load-amount determination unit 130 determines the extracted uncore frequency as the setting value of the optimum frequency (step S310). Then, the processing proceeds to step S312.

In step S304, when the number of candidates is “none”, that is, no candidate for the optimum uncore frequency is found, the frequency-per-load-amount determination unit 130 determines the setting value of the optimum frequency on the basis of logic set in advance (step S311).

For example, the frequency-per-load-amount determination unit 130 adopts the uncore frequency extracted with the load amount close to the load amount for which there is no candidate, or adopts the average value of the uncore frequencies extracted with the load amounts of upper and lower values of the load amount for which there is no candidate. Then, the processing proceeds to step S312.

In step S312, the frequency-per-load-amount determination unit 130 stores the uncore frequency determined as the setting value or the optimum width of the uncore frequency in the data store 300 in association with the load amount (HW operation status data).

As a result, the frequency-per-load-amount determination unit 130 can determine the optimum setting value of the uncore frequency for each load amount and store the setting value in the data store 300.

### [Control Rule Creation Processing]

FIG. 9 is a flowchart illustrating a flow of control rule creation processing performed by the uncore frequency control device 1 according to the present embodiment.

The control rule creation unit 140 of the uncore frequency control device 1 creates a control rule by replacing each load amount with the performance data serving as the control determination reference value by using the setting value of the optimum uncore frequency satisfying the user requirement for each load amount determined by the frequency-per-load-amount determination unit 130.

First, the control rule creation unit 140 acquires information of the setting value of the optimum uncore frequency determined for each load amount from the data store 300 (step S401).

Next, the control rule creation unit 140 creates a control rule 400 indicating an optimum uncore frequency to be set according to the value of the load amount by replacing each load amount with performance data serving as a control determination reference value (step S402).

Specifically, for example, the control rule creation unit 140 replaces the CPU usage rate which is the measurement data (HW operation status data) as each load amount with the performance data which is the control determination reference value, and creates the control rule 400 using the performance data as the reference value for determining switching of the setting of the uncore frequency (see FIG. 4). The control rule creation unit 140 may use, for example, an intermediate value of two load amounts (HW operation status data) as the performance data serving as the control determination reference instead of the value itself of the CPU usage rate which is the measurement data (HW operation status data) (see FIG. 5).

Subsequently, the control rule creation unit 140 stores the created control rule 400 in the storage unit 12 (step S403).

As a result, the control rule creation unit 140 can store the control rule 400 for determining the optimum uncore frequency in the storage unit 12 in advance on the basis of the load amount (here, the HW operation status data) of each piece of compute 2.

### [Uncore Frequency Control Processing <1>]

FIG. 10 is a flowchart illustrating a flow of uncore frequency control processing <1> performed by the uncore frequency control device 1 according to the present embodiment.

The uncore frequency control processing <1> is control processing of the uncore frequency for each piece of compute 2 in a case where it is determined that the performance requirements are set for the entire App. When the compute 2 is in an operating state, that is, when providing a service by web or an App, the uncore frequency control device 1 executes the uncore frequency control processing <1> on each piece of compute 2, so that it is possible to always perform control with the optimum uncore frequency.

The uncore frequency control device 1 repeats the following uncore frequency control processing <1> for the number of pieces of compute 2 to be controlled (steps S501 to S506).

First, the uncore frequency control device 1 selects one of the pieces of compute 2 to be controlled and executes the processing in and after step S502.

In step S502, the monitoring unit 150 of the uncore frequency control device 1 acquires HW operation status data (for example, CPU usage rate) indicating the current load amount from the compute 2 to be controlled.

Next, the uncore frequency determination unit 160 of the uncore frequency control device 1 determines the optimum uncore frequency at the current time point by applying the control rule 400 stored in the storage unit 12 by using the HW operation status data acquired by the monitoring unit 150 (step S503). For example, the uncore frequency determination unit 160 can determine the optimum uncore frequency from the CPU usage rate which is the current HW operation status data by referring to the control rule 400 as illustrated in FIG. 4.

The uncore frequency determination unit 160 compares the this-time determined uncore frequency with the currently set uncore frequency in the compute 2 and determines whether the frequencies are the same (step S504). That is, it is determined whether the currently set uncore frequency in the compute 2 is the optimum uncore frequency.

Here, if the this-time determined uncore frequency and the currently set uncore frequency are the same (step S504: Yes), it is determined that the optimum uncore frequency has been set, and the processing proceeds to the next step S506.

On the other hand, if the this-time determined uncore frequency and the currently set uncore frequency are not the same (step S504: No), the uncore frequency determination unit 160 determines the this-time determined uncore frequency as the optimum uncore frequency of the compute 2 at the current time point. Then, the frequency control unit 170 transmits the setting information of the optimum uncore frequency at the current time point to the compute 2 (step S505). As a result, the uncore frequency of the compute 2 is changed to an optimum value at the current time point. Then, the processing proceeds to next step S506.

If there is a compute 2 for which the uncore frequency control processing <1> has not been executed yet among pieces of the compute 2 to be controlled, the uncore frequency control device 1 returns to step S501 and continues the processing (step S506). On the other hand, when processing for all of the pieces of compute 2 to be controlled has been completed, the processing proceeds to step S507.

In step S507, the uncore frequency control device 1 determines whether the service of the web or App is ended, and if the service is not ended (step S507: No), the processing returns to step S501 and processing on all the target pieces of compute 2 continues. On the other hand, when the service of the web or App is ended (step S507: Yes), the processing of the uncore frequency control processing <1> ends.

As a result, the uncore frequency control device 1 can always set the optimum uncore frequency for each piece of compute 2 during the operation of the service of the web or App by each piece of compute 2.

### [Uncore Frequency Control Processing <2>]

FIG. 11 is a flowchart illustrating a flow of uncore frequency control processing <2> performed by the uncore frequency control device 1 according to the present embodiment.

The uncore frequency control processing <2> is control processing of the uncore frequency for each piece of compute 2 in a case where it is not necessary to consider the performance requirement for a part of the App. When the compute 2 is in an operating state, that is, when providing a service by web or an App, the uncore frequency control device 1 executes the uncore frequency control processing <2> on each piece of compute 2, so that it is possible to always perform control with the optimum uncore frequency.

The uncore frequency control device 1 repeats the following uncore frequency control processing <2> for the number of pieces of compute 2 to be controlled (steps S601 to S611).

First, the uncore frequency control device 1 selects one of the pieces of compute 2 to be controlled and executes the processing in and after step S602.

In step S602, the uncore frequency control device 1 determines whether all Apps (or function groups constituting an App) exist on the same physical server for the compute 2 with reference to the App performance range information 100 in the storage unit 12. Then, when all Apps do not exist on the same physical server (step S602: No), that is, when a function group for which consideration of the performance requirement is not necessary operates on another server (for example, DB server), the processing proceeds to step S603.

In step S603, the uncore frequency determination unit 160 sets an uncore frequency (for example, the minimum value of the settable range) lower than a predetermined threshold to the physical server on which the function group that needs no consideration of the performance requirement operates.

Then, in step S604, the uncore frequency determination unit 160 executes the uncore frequency control processing <1> in step S502 to 505 of FIG. 10 on the physical server on which the function group considering the performance requirements operates. Then, the processing proceeds to next step S611.

Returning to step S602, the description is continued.

When all Apps are present on the same physical server (step S602: Yes), the processing proceeds to step S605.

In step S605, the monitoring unit 150 of the uncore frequency control device 1 acquires HW operation status data indicating the current load amount from the compute 2 to be controlled. The HW operation status data includes, in addition to the data of the CPU usage rate which is an index of the load amount, information such as a cache miss and a memory bandwidth, and data for determining whether the processing is processing in which the load is concentrated on the memory.

Subsequently, the uncore frequency determination unit 160 determines whether a load is concentrated on the memory on the basis of the HW operation status data of the compute 2 (step S606). Here, when it is determined that the load is concentrated on the memory (step S606: Yes), the processing proceeds to step S607, and the uncore frequency determination unit 160 sets an uncore frequency (for example, the minimum value of the settable range) lower than a predetermined threshold to the compute 2.

On the other hand, when the uncore frequency determination unit 160 determines that the load is not concentrated on the memory (step S606: No), that is, when it is determined that the load is concentrated on the CPU, the processing proceeds to step S608.

In step S608, the uncore frequency determination unit 160 of the uncore frequency control device 1 determines the optimum uncore frequency at the current time point by applying the control rule 400 stored in the storage unit 12 by using the HW operation status data acquired by the monitoring unit 150. For example, the uncore frequency determination unit 160 can determine the optimum uncore frequency from the CPU usage rate which is the current HW operation status data by referring to the control rule 400 as illustrated in FIG. 4.

The uncore frequency determination unit 160 compares the this-time determined uncore frequency with the currently set uncore frequency in the compute 2 and determines whether the frequencies are the same (step S609).

Here, if the this-time determined uncore frequency and the currently set uncore frequency are the same (step S609: Yes), it is determined that the optimum uncore frequency has been set, and the processing proceeds to the next step S611.

On the other hand, if the this-time determined uncore frequency and the currently set uncore frequency are not the same (step S609: No), the uncore frequency determination unit 160 determines the this-time determined uncore frequency as the optimum uncore frequency of the compute 2 at the current time point. Then, the frequency control unit 170 transmits the setting information of the optimum uncore frequency at the current time point to the compute 2 (step S610). As a result, the uncore frequency of the compute 2 is changed to an optimum value at the current time point. Then, the processing proceeds to next step S611.

If there is compute 2 for which the uncore frequency control processing <2> has not been executed yet among the pieces of compute 2 to be controlled, the uncore frequency control device 1 returns to step S601 and continues the processing (step S611). On the other hand, when processing for all of the pieces of compute 2 to be controlled has been completed, the processing proceeds to step S612.

In step S612, the uncore frequency control device 1 determines whether the service of the web or App is ended, and if the service is not ended (step S612: No), the processing returns to step S601 and processing on all the target pieces of compute 2 continues. On the other hand, when the service of the web or App is ended (step S612: Yes), the processing of the uncore frequency control processing <2> ends.

As a result, the uncore frequency control device 1 can always set the optimum uncore frequency for each piece of compute 2 during the operation of the service of the web or App even when it is not necessary to consider the performance requirement for a part of the App in the compute 2.

### <Hardware Configuration>

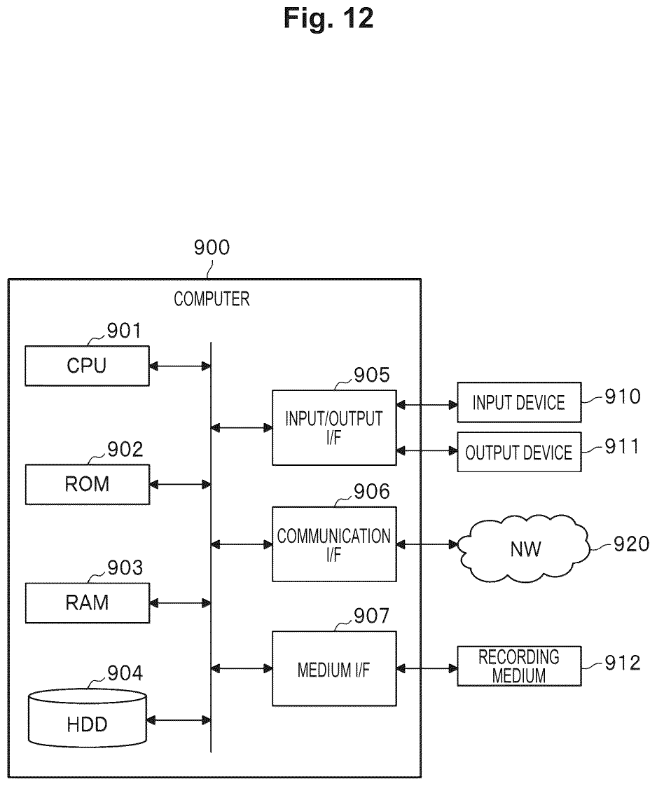

The uncore frequency control device 1 according to the present embodiment is implemented by, for example, a computer 900 having a configuration as illustrated in FIG. 12.

FIG. 12 is a hardware configuration diagram illustrating an example of a computer 900 that implements functions of the uncore frequency control device 1 according to the present embodiment. The computer 900 includes a CPU 901, a read only memory (ROM) 902, a RAM 903, a hard disk drive (HDD) 904, an input/output interface (I/F) 905, a communication I/F 906, and a media I/F 907.

The CPU 901 operates on the basis of a program (uncore frequency control program) stored in the ROM 902 or the HDD 904, and performs control by the control unit 10 (FIG. 1). The ROM 902 stores a boot program to be executed by the CPU 901 when the computer 900 is started, a program related to hardware of the computer 900, and the like.

The CPU 901 controls an input device 910 such as a mouse or a keyboard and an output device 911 such as a display or a printer via the input/output I/F 905. The CPU 901 acquires data from the input device 910 and outputs generated data to the output device 911 via the input/output I/F 905. Note that a graphics processing unit (GPU), or the like, may be used as a processor together with the CPU 901.

The HDD 904 stores a program to be executed by the CPU 901, data to be used by the program, and the like. The communication I/F 906 receives data from another device via a communication network (for example, a network (NW) 920), outputs the data to the CPU 901, and transmits data generated by the CPU 901 to another device via the communication network.

The medium I/F 907 reads a program (uncore frequency control program) or data stored in a recording medium 912, and outputs the read program or data to the CPU 901 via the RAM 903. The CPU 901 loads a program related to target processing from the recording medium 912 into the RAM 903 via the media I/F 907 and executes the loaded program. The recording medium 912 is an optical recording medium such as a digital versatile disc (DVD) or a phase change rewritable disk (PD), a magneto-optical recording medium such as a magneto optical disk (MO), a magnetic recording medium, a semiconductor memory, or the like.

For example, in a case where the computer 900 functions as the uncore frequency control program of the present invention, the CPU 901 of the computer 900 achieves the function of the uncore frequency control program by executing the program loaded on the RAM 903. In addition, the HDD 904 stores data in the RAM 903. The CPU 901 reads a program related to target processing from the recording medium 912 and executes the program. Additionally, the CPU 901 may read a program related to target processing from another device via the communication network (NW 920).

### Effects

Hereinafter, effects of the uncore frequency control device and the like according to the present invention is described.

An uncore frequency control device according to the present invention is an uncore frequency control device 1 that controls an uncore frequency of a physical server group being pieces of compute 2, the uncore frequency control device implementing an App that executes real-time processing, the uncore frequency control device including: a requirement acquisition unit 110 that acquires a user requirement related to performance and power consumption; a data collection unit 120 that changes each of a load amount applied to the compute 2 and an uncore frequency set in the compute 2 and collects prior data including an App performance value, power consumption, and HW operation status data of the compute 2 for a predetermined period; a frequency-per-load-amount determination unit 130 that refers to the prior data, extracts an uncore frequency that satisfies the user requirement for each of the load amount, and determines a setting value of the uncore frequency for each of the load amount; a control rule creation unit 140 that creates a control rule 400 indicating an uncore frequency to be set according to a value of the load amount by replacing each of the load amount with performance data serving as a control determination reference value for determining the uncore frequency by using the setting value of the uncore frequency for each of the load amount; a monitoring unit 150 that acquires the load amount of a current time point indicated by the HW operation status data from the compute 2 on which the App is executing the real-time processing; an uncore frequency determination unit 160 that determines an uncore frequency to be set in the compute 2 by applying the control rule 400 by using the load amount of the current time acquired from the compute 2; and a frequency control unit 170 that transmits the uncore frequency that has been determined to the compute 2 and causes the uncore frequency to be set.

As a result, the uncore frequency control device 1 can satisfy the user requirement regarding the performance and the power consumption, that is, reduce the power consumption while maintaining the performance, and can set the optimum uncore frequency corresponding to the real-time processing of the App in the compute 2.

In the uncore frequency control device 1, the user requirement is a performance degradation requirement indicating a ratio at which performance degradation is allowed, a power reduction requirement indicating a power consumption reduction effect, and information indicating either performance priority or energy saving priority, and the frequency-per-load-amount determination unit 130 extracts an uncore frequency having performance equal to or higher than the performance threshold indicated by the performance degradation requirement and power consumption equal to or lower than the power threshold indicated by the power reduction requirement, determines a setting value of the uncore frequency of the load amount as the uncore frequency when the extracted uncore frequency is single, and determines a maximum value among a plurality of the extracted uncore frequencies as the setting value of the uncore frequency of the load amount when the performance priority is set in the user requirement when the performance priority is set in a plurality of the extracted uncore frequencies, and, when energy saving priority is set in the user requirement, determines the minimum value among a plurality of the uncore frequency that has been extracted as the setting value of the uncore frequency of the load amount.

As described above, the uncore frequency control device 1 acquires, as the user requirement, the performance degradation requirement indicating the ratio at which performance degradation is allowed, the power reduction requirement indicating the power consumption reduction effect, and the information indicating either performance priority or energy saving priority. As a result, the uncore frequency control device 1 extracts an uncore frequency that has performance equal to or higher than the performance threshold indicated by the performance degradation requirement and is power consumption equal to or lower than the power threshold indicated by the power reduction requirement. Then, even when there is a plurality of extracted uncore frequencies, the uncore frequency control device 1 can determine the setting value of the uncore frequency according to the user requirement by using information indicating either performance priority or energy saving priority.

In addition, in the uncore frequency control device 1, the storage unit 12 of the uncore frequency control device 1 stores App performance range information indicating that it is necessary to consider the performance of the App or the entire function group constituting the App or that it is unnecessary to consider the performance for a part of the App or the function group constituting the App, the monitoring unit 150 acquires information for determining whether the processing is processing in which the load is concentrated on the memory of the physical server together with the HW operation status data, in a case where the function group for which the performance is considered and the function group for which the performance is not considered among the function groups constituting the App are operating on different physical servers from each other, the uncore frequency determination unit 160 sets an uncore frequency lower than a predetermined threshold in the physical server on which the function group not considering the performance operates, and in a case where a function group for which the performance is considered and a function group for which the performance is not considered among the function groups constituting the App are operating on the same physical server, the uncore frequency determination unit 160 sets an uncore frequency lower than a predetermined threshold when determining that processing in which a load is concentrated on the memory is being executed.

As described above, by storing the App performance range information 100 in the storage unit 12, the uncore frequency control device 1 can set the uncore frequency lower than the predetermined threshold (for example, the minimum value of the settable range) in a case where it is not necessary to consider the performance for a part of the function group. This is because it is not necessary to consider the performance requirement of the DB server that does not require high-speed processing even in the processing in which the load is concentrated on the memory, and the uncore frequency control device 1 can set a low uncore frequency. Therefore, the uncore frequency control device 1 can further reduce power consumption.

Note that the present invention is not limited to the above-described embodiment, and many modifications can be made by those skilled in the art within the technical idea of the present invention.

### REFERENCE SIGNS LIST

1 Uncore frequency control device
2 Compute (physical server)
10 Control unit
11 Input/output unit
12 Storage unit
21 Data collection software
22 IPMI
100 App performance range information
110 Requirement acquisition unit
120 Data collection unit
130 Frequency-per-load-amount determination unit
140 Control rule creation unit
150 Monitoring unit
160 uncore frequency determination unit
170 Frequency control unit
200 App (application)
300 Data store
400 Control rule
1000 Uncore frequency control system

What is claimed:

1. An uncore frequency control device that controls an uncore frequency of a physical server group being pieces of compute in which an application (App) that executes real-time processing is implemented,
the uncore frequency control device comprising:
a requirement acquirer configured to acquire a user requirement related to performance and power consumption;
a data collector configured to change each of a load amount applied to the compute and an uncore frequency set in the compute and collects prior data including an App performance value, power consumption, and hardware (HW) operation status data of the compute for a predetermined period;
a frequency-per-load-amount determinator configured to refer to the prior data, extract an uncore frequency that satisfies the user requirement for each of the load amount, and determine a setting value of the uncore frequency for each of the load amount;
a control rule creator configured to create a control rule indicating an uncore frequency to be set according to a value of the load amount by replacing each of the load amount with performance data serving as a control determination reference value for determining the uncore frequency by using the setting value of the uncore frequency for each of the load amount;
a monitor configured to acquire the load amount of a current time point indicated by the HW operation status data from the compute on which the App is executing the real-time processing;
an uncore frequency determinator configured to determine an uncore frequency to be set in the compute by applying the control rule by using the load amount of the current time point acquired from the compute; and
a frequency controller configured to transmit the uncore frequency that has been determined to the compute and causes the uncore frequency to be set.

2. The uncore frequency control device according to claim 1,
wherein the user requirement is a performance degradation requirement indicating a ratio at which performance degradation is allowed, a power reduction requirement indicating a power consumption reduction effect, and information indicating either performance priority or energy saving priority, and
the frequency-per-load-amount determinator extracts an uncore frequency having performance equal to or higher than a performance threshold indicated by the performance degradation requirement and power consumption equal to or lower than a power threshold indicated by the power reduction requirement, determines a setting value of the uncore frequency of the load amount as the uncore frequency when the extracted uncore frequency is single, and determines a maximum value among a plurality of the extracted uncore frequencies as the setting value of the uncore frequency of the load amount when the performance priority is set in the user requirement when the uncore frequency that has been extracted is plural, and, when energy saving priority is set in the user requirement, the minimum value among a plurality of the uncore frequency that has been extracted is determined as the setting value of the uncore frequency of the load amount.

3. The uncore frequency control device according to claim 1,
wherein a storage of the uncore frequency control device stores App performance range information indicating that it is necessary to consider performance of the App or entire of function group included in the App or that it is unnecessary to consider performance for a part of the App or the function group included in the App,
the monitor acquires information for determining whether processing is processing in which a load is concentrated on a memory of the physical server together with the HW operation status data,
in a case where the function group for which performance is considered and the function group for which performance is not considered among the function group included in the App are operating on different physical servers from each other, the uncore frequency determinator sets an uncore frequency lower than a predetermined threshold in the physical server on which the function group for which performance is not considered operates, and
in a case where the function group for which performance is considered and the function group for which performance is not considered among the function group constituting the App are operating on the same physical server, the uncore frequency determinator sets an uncore frequency lower than a predetermined threshold when determining that processing in which a load is concentrated on the memory is being executed.

4. An uncore frequency control method of an uncore frequency control device that controls an uncore frequency of a physical server group being pieces of compute in which an App that executes real-time processing is implemented,
wherein the uncore frequency control device executes:
acquiring a user requirement related to performance and power consumption;
changing each of a load amount applied to the compute and an uncore frequency set in the compute and collecting prior data including an App performance value, power consumption, and hardware (HW) operation status data of the compute for a predetermined period;
referring to the prior data, extracting an uncore frequency that satisfies the user requirement for each of the load amount, and determining a setting value of the uncore frequency for each of the load amount;
creating a control rule indicating an uncore frequency to be set according to a value of the load amount by replacing each of the load amount with performance data serving as a control determination reference value for determining the uncore frequency by using the setting value of the uncore frequency for each of the load amount;
acquiring the load amount of a current time point indicated by the HW operation status data from the compute on which the App is executing the real-time processing;
determining an uncore frequency to be set in the compute by applying the control rule by using the load amount of the current time point acquired from the compute; and
transmitting the uncore frequency that has been determined to the compute and causing the uncore frequency to be set.

5. A non-transitory computer-readable storage medium storing an uncore frequency control program for causing a computer to operate as an uncore frequency control device that controls an uncore frequency of a physical server group being pieces of compute in which an App that executes real-time processing is implemented, to execute:
acquiring a user requirement related to performance and power consumption;
changing each of a load amount applied to the compute and an uncore frequency set in the compute and collecting prior data including an App performance value, power consumption, and hardware (HW) operation status data of the compute for a predetermined period;
referring to the prior data, extracting an uncore frequency that satisfies the user requirement for each of the load amount, and determining a setting value of the uncore frequency for each of the load amount;
creating a control rule indicating an uncore frequency to be set according to a value of the load amount by replacing each of the load amount with performance data serving as a control determination reference value for determining the uncore frequency by using the setting value of the uncore frequency for each of the load amount;
acquiring the load amount of a current time point indicated by the HW operation status data from the compute on which the App is executing the real-time processing;
determining an uncore frequency to be set in the compute by applying the control rule by using the load amount of the current time point acquired from the compute; and
transmitting the uncore frequency that has been determined to the compute and causing the uncore frequency to be set.
